(19) United States
(12) Patent Application Publication
(10) Pub. No.: US 2024/0104115 A1
(43) Pub. Date: Mar. 28, 2024

(54) METHOD AND APPARATUS FOR CONVERTING CREDENTIAL DATA SCHEMA

(71) Applicant: ELECTRONICS AND TELECOMMUNICATIONS RESEARCH INSTITUTE, Daejeon (KR)

(72) Inventors: Seok-Hyun KIM, Daejeon (KR); Soo-Hyung KIM, Daejeon (KR); Young-Seob CHO, Daejeon (KR); Geon-Woo KIM, Daejeon (KR); Young-Sam KIM, Daejeon (KR); Jong-Hyouk NOH, Daejeon (KR); Kwan-Tae CHO, Daejeon (KR); Sang-Rae CHO, Okcheon-gun (KR); Jin-Man CHO, Daejeon (KR); Seung-Hun JIN, Daejeon (KR)

(73) Assignee: ELECTRONICS AND TELECOMMUNICATIONS RESEARCH INSTITUTE, Daejeon (KR)

(21) Appl. No.: 18/350,083

(22) Filed: Jul. 11, 2023

(30) Foreign Application Priority Data
Sep. 23, 2022 (KR) 10-2022-0120674

(51) Int. Cl. G06F 16/25; H04L 9/32

(52) U.S. Cl. CPC G06F 16/258; H04L 9/3263

(57) ABSTRACT

Disclosed herein are a method and apparatus for converting a credential data schema. The method for converting a credential data schema includes checking credential data in response to a credential data schema conversion request statement received from a requester terminal, and checking a decentralized identifier of a credential issuer based on the credential data, retrieve a decentralized identifier document through a decentralized identifier resolver, verifying a credential to be converted based on the decentralized identifier document, when verification of the credential is completed, generating a credential data schema identifier for the credential, retrieving a credential data conversion schema corresponding to the credential data schema conversion request statement based on the credential data schema identifier, converting the credential data schema based on the credential data conversion schema and generating a credential data schema conversion result, and checking identity information of the credential issuer through an issuer identity information registry.

### CROSS REFERENCE TO RELATED APPLICATION

This application claims the benefit of Korean Patent Application No. 10-2022-0120674, filed Sep. 23, 2022, which is hereby incorporated by reference in its entirety into this application.

### BACKGROUND OF THE INVENTION

### 1. Technical Field

The present disclosure relates to a method and apparatus for mechanically identifying a credential data schema for verifiable credentials and converting the credential data schema into a specific credential schema.

### 2. Description of the Related Art

Recently, a multi-decentralized identity management service environment has emerged in which, through a decentralized identity management service using Decentralized Identifiers (DIDs) allowing users to manage and control their identity information, the users can manage verifiable credentials, and in which a verifier verifies the credentials of the users issued by different decentralized identity management services to provide the service based on the verified credentials.

The users may be issued credentials configured in different credential data schemas (or credential schemas) or credentials written in a foreign language from respective certification agencies even when credentials having the same purpose (e.g., degree certificates or degree credentials) are issued in a conventional multi-decentralized identity management service environment.

Therefore, the verifier needs to verify credentials configured in various types of credential data schemas and requires considerable manual work in order to check and aggregate credential data schemas in a verification stage.

Further, in a future multi-decentralized identity management service environment, credential data schemas can become more diverse, which can hinder the scalability and interoperability of the decentralized identity management service.

### SUMMARY OF THE INVENTION

Accordingly, the present disclosure has been made keeping in mind the above problems occurring in the prior art, and an object of the present disclosure is to provide a method and apparatus for converting a credential data schema, which can convert a credential data schema for credentials into a mechanically identifiable credential data schema.

In accordance with an aspect of the present disclosure to accomplish the above object, there is provided a method for converting a credential data schema, including checking credential data in response to a credential data schema conversion request statement received from a requester terminal, and checking a decentralized identifier of a credential issuer based on the credential data, retrieving a decentralized identifier document through a decentralized identifier resolver, verifying a credential to be converted based on the decentralized identifier document, when verification of the credential is completed, generating a credential data schema identifier for the credential, retrieving a credential data conversion schema corresponding to the credential data schema conversion request statement based on the credential data schema identifier, converting the credential data schema based on the credential data conversion schema and generating a credential data schema conversion result, and checking identity information of the credential issuer through an issuer identity information registry.

The method may further include generating credential data schema conversion metadata for the converted credential data schema.

The credential data schema conversion metadata may include at least one of meta-information of a source credential data schema, meta-information of a target credential data schema, meta-information of a credential data conversion schema or the identity information of the credential issuer, or a combination thereof.

The method may further include generating guarantee information of the credential data schema conversion result, signed with a private key associated with a decentralized identifier of a converter in order to verify integrity of the credential data schema conversion result and the credential data schema conversion metadata.

The method may further include providing a credential data schema conversion response statement including at least one of a credential document, the credential data schema conversion metadata, the credential data schema conversion result or the guarantee information of the credential data schema conversion result, or a combination thereof to the request terminal in response to the credential data schema conversion request statement.

The requester terminal may verify the guarantee information of the credential data schema conversion result based on the credential data schema conversion response statement, and may confirm the credential data schema conversion result and the credential data schema conversion metadata.

The credential data schema identifier may be generated based on type information of the credential and decentralized identifier information of the credential issuer.

The credential data schema identifier may be generated based on information about a data schema of the credential.

The credential data schema conversion result may include converted credential data schema information and unconverted credential data schema information.

The credential data conversion schema may be created based on input of a converter, and the created credential data conversion schema is registered and managed using a credential data conversion schema repository.

In accordance with another aspect of the present disclosure to accomplish the above object, there is provided an apparatus for converting a credential data schema, including memory configured to store a control program for converting a credential data schema, and a processor configured to execute the control program stored in the memory, wherein the processor is configured to check credential data in response to a credential data schema conversion request statement received from a requester terminal, check a decentralized identifier of a credential issuer based on the credential data, retrieve a decentralized identifier document through a decentralized identifier resolver, verify a credential to be converted based on the decentralized identifier document, when verification of the credential is completed, generate a credential data schema identifier for the credential, retrieve a credential data conversion schema corresponding to the credential data schema conversion request statement based on the credential data schema identifier, convert the credential data schema based on the credential data conversion schema, generate a credential data schema conversion result, and check identity information of the credential issuer through an issuer identity information registry.

The processor may be configured to generate credential data schema conversion metadata for the converted credential data schema.

The credential data schema conversion metadata may include at least one of meta-information of a source credential data schema, meta-information of a target credential data schema, meta-information of a credential data conversion schema or the identity information of the credential issuer, or a combination thereof.

The processor may be configured to generate guarantee information of the credential data schema conversion result, signed with a private key associated with a decentralized identifier of a converter in order to verify integrity of the credential data schema conversion result and the credential data schema conversion metadata.

The processor may be configured to provide a credential data schema conversion response statement including at least one of a credential document, the credential data schema conversion metadata, the credential data schema conversion result or the guarantee information of the credential data schema conversion result, or a combination thereof to the request terminal in response to the credential data schema conversion request statement.

The requester terminal may verify the guarantee information of the credential data schema conversion result based on the credential data schema conversion response statement, and may confirm the credential data schema conversion result and the credential data schema conversion metadata.

The credential data schema identifier may be generated based on type information of the credential and decentralized identifier information of the credential issuer.

The credential data schema identifier may be generated based on information about a data schema of the credential.

The credential data schema conversion result may include converted credential data schema information and unconverted credential data schema information.

The credential data conversion schema may be created based on input of a converter, and the created credential data conversion schema is registered and managed using a credential data conversion schema repository.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a block diagram illustrating a system for converting a credential data schema according to an embodiment;

FIG. 2 is a diagram illustrating a model corresponding to the result of conversion by an apparatus for converting a credential data schema according to an embodiment;

FIG. 3 is a diagram illustrating an example of the result of conversion of a credential data schema according to an embodiment;

FIG. 4 is a diagram illustrating credential data schema conversion data according to an embodiment;

FIG. 5 is a diagram illustrating sample data of a credential document according to an embodiment;

FIG. 6 is a diagram illustrating sample data of credential data schema conversion metadata according to an embodiment;

FIG. 7 is a diagram illustrating sample data of a credential data schema conversion result according to an embodiment;

FIG. 8 is a diagram illustrating sample data indicating the guarantee information of credential data schema conversion result according to an embodiment;

FIG. 9 is a diagram illustrating a User Interface (UI) screen for creating a credential data schema according to an embodiment;

FIG. 10 is a diagram illustrating a UI screen for creating a credential data conversion schema according to an embodiment;

FIG. 11 is a flowchart illustrating a process of converting a credential data schema according to an embodiment; and

FIG. 12 is a block diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Embodiments of the present disclosure will now be described in detail with reference to the accompanying drawings. Like numerals refer to like elements throughout, and overlapping descriptions will be omitted.

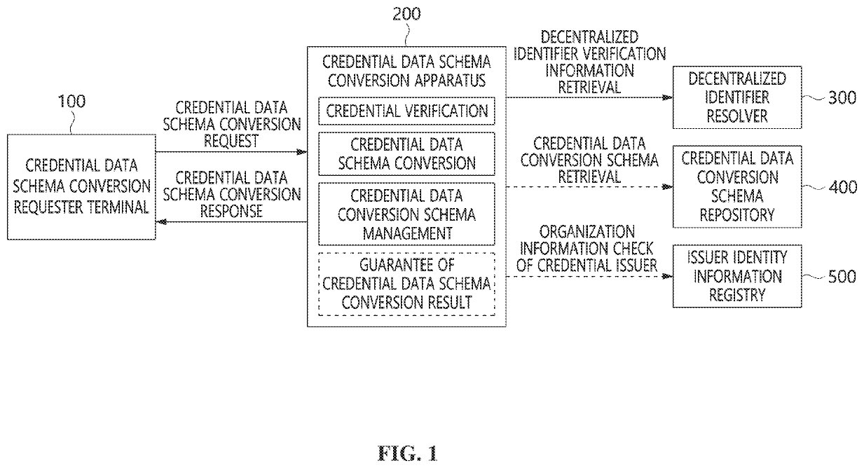

FIG. 1 is a block diagram illustrating a system for converting a credential data schema according to an embodiment.

Referring to FIG. 1, the credential data schema conversion system according to an embodiment may include a requester terminal 100, an apparatus 200 for converting a credential data schema (hereinafter also referred to as a “credential data schema conversion apparatus 200”), a decentralized identifier resolver 300, a credential data conversion schema repository 400, and an issuer identity information registry 500.

The requester terminal 100 may be a terminal owned by a requester who requests conversion of a credential data schema. The requester may be a user who is issued credentials and submits the credentials to use the corresponding service, or a verifier who verifies the credentials submitted by the user and provides the service. The requester terminal 100 may request the conversion of a credential data schema based on the input of the requester.

The requester terminal 100 may include, but is not limited to, a computer, a mobile terminal, a wearable device, or the like that can be connected over a network.

For example, the computer may include a notebook, a desktop, a laptop, etc., each equipped with a web browser, and the mobile terminal may be a wireless communication device guaranteeing portability and mobility, and may include all types of handheld wireless communication devices such as Long-Term Evolution (LTE), LTE-A, Personal Digital Cellular (PDC), Personal Handyphone System (PHS), Personal Digital Assistant (PDA), Global System for Mobile communications (GSM), International Mobile Telecommunication (IMT), Code Division Multiple Access (CDMA), Wideband-Code Division Multiple Access (W-CDMA), Wireless Broadband Internet (Wibro), smartphone, and Mobile Worldwide Interoperability for Microwave Access (WIMAX).

Furthermore, the wearable device may include an information processing device directly wearable on a human body, for example, a watch, glasses, accessories, clothes, shoes, or a smart watch.

The credential data schema conversion apparatus 200 may convert a source (original) credential data schema received from the requester terminal 100 into a target credential data schema, and may provide the result of conversion. The credential data schema conversion apparatus 200 may be, but is not limited to, a server or a terminal.

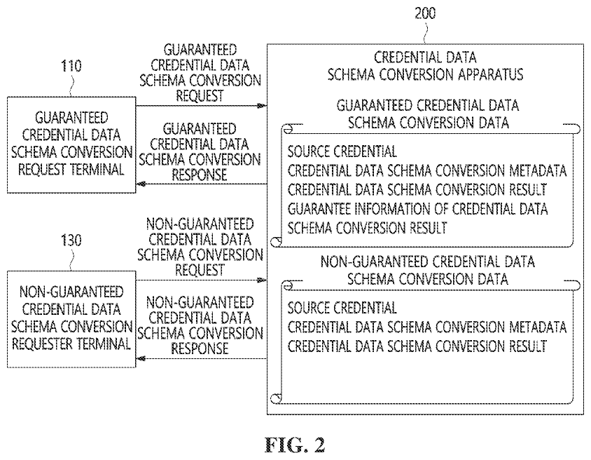

FIG. 2 is a diagram illustrating a model corresponding to the result of conversion by an apparatus for converting a credential data schema according to an embodiment.

As illustrated in FIG. 2, the credential data schema conversion apparatus 200 according to an embodiment may provide the result of credential data schema conversion both to a guaranteed credential data schema conversion model and to a non-guaranteed credential data schema conversion model.

When a request for schema conversion is received from a guaranteed credential data schema conversion requester terminal 110 that is the requester terminal, the guaranteed credential data schema conversion model may be a model including the signature of a converter in the credential data schema conversion data as the result of conversion in order to improve the reliability of the result of credential data schema conversion. For example, the guaranteed credential data schema conversion model may include at least one of a source credential, credential data schema conversion metadata, the result of credential data schema conversion or guarantee information of the result of credential data schema conversion, or a combination thereof.

The non-guaranteed credential data schema conversion model may be a model in which the signature of the converter is not included in credential data schema conversion data obtained in response to a schema conversion request from a non-guaranteed credential data schema conversion requester terminal 130 that is the requester terminal. For example, the non-guaranteed credential data schema conversion model may include at least one of a source credential, credential data schema conversion metadata or the result of credential data schema conversion, or a combination thereof.

Referring back to FIG. 1, the credential data schema conversion apparatus 200 according to the embodiment may perform functions such as credential verification, conversion of the credential data schema, management of a credential data conversion schema, and the guarantee of the credential data conversion result.

The credential data schema conversion apparatus 200 may validate the data structure of the source credential and verify whether the source credential is forged/falsified, and may check and verify the identity information of the credential issuer to perform credential verification if necessary. The identity information of the issuer may be checked through the issuer identity information registry 500.

The credential data schema conversion apparatus 200 may convert the source credential data schema into a target credential data schema.

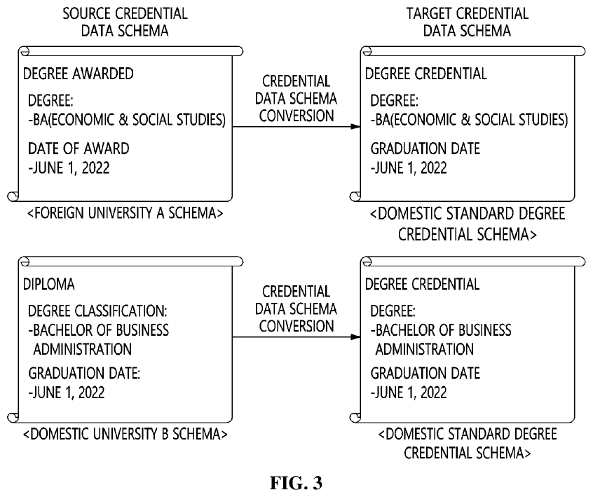

FIG. 3 is a diagram illustrating an example of the result of conversion of a credential data schema according to an embodiment.

As illustrated in FIG. 3, the credential data schema conversion apparatus according to the embodiment may convert a degree credential data schema used by foreign universities written in a foreign language and a degree credential data schema internally used by domestic universities into a domestic standard degree credential data schema that is interpretable by a verifier.

Referring back to FIG. 1, the credential data schema conversion apparatus 200 according to the embodiment may allow a converter to directly create, store, and manage the credential data conversion schema required for converting the source credential data schema into the target credential data schema. Further, if necessary, the credential data conversion schema may be registered and managed in the credential data conversion schema repository 400.

The credential data schema conversion apparatus 200 according to the embodiment may guarantee the result of credential data conversion by including the signature of the converter in the credential data schema conversion data in order to improve the reliability of data indicating the result of credential data schema conversion.

The decentralized identifier resolver 300 may retrieve and respond with decentralized identifier documents through trusted repositories for different decentralized identity management services.

The credential data conversion schema repository 400 may be an open repository in which credential data conversion schemas created by different credential data schema converters can be registered and shared.

The issuer identity information registry 500 may verify pieces of organization certification information submitted by the credential issuers of different decentralized identity management services, generate identity information of the issuers using the verified organization certificate information, and store and manage the generated identity information of the issuers in association with the decentralized identifiers of the issuers.

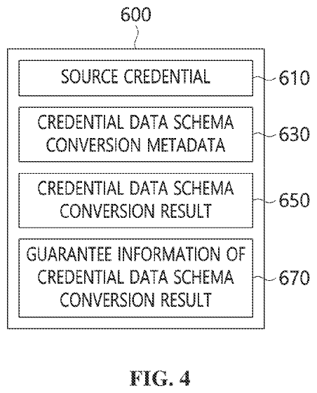

FIG. 4 is a diagram illustrating credential data schema conversion data according to an embodiment.

As illustrated in FIG. 4, credential data schema conversion data 600 may include a source credential 610, credential data schema conversion metadata 630, a credential data schema conversion result 650, and guarantee information 670 of the credential data schema conversion result.

The source credential 610 may be a credential document, the conversion of which is requested by the credential data schema conversion requester terminal 100.

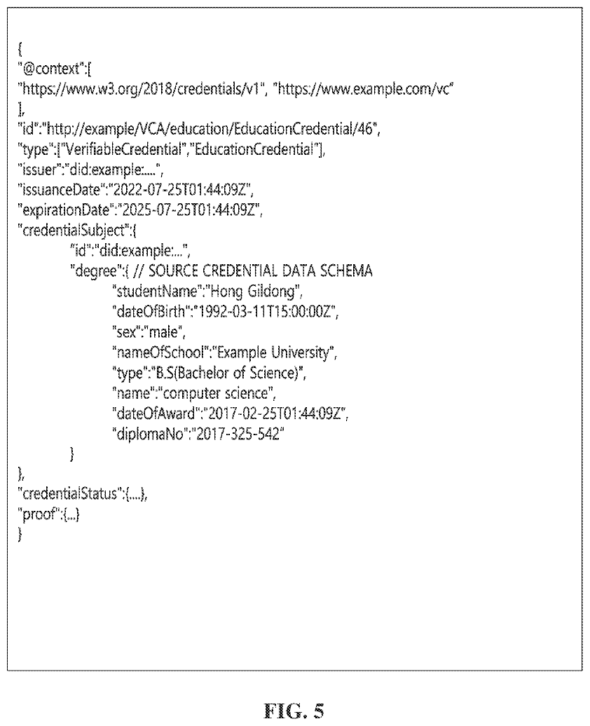

FIG. 5 is a diagram illustrating sample data of a credential document according to an embodiment.

As illustrated in FIG. 5, the credential document may apply W3C Verifiable Credentials Data Model 1.1.

Referring back to FIG. 4, the credential data schema conversion metadata 630 may be information that is usable to determine the reliability of the credential data schema and the conversion data. This information includes identifiers of the source credential data schema, the target credential data schema, and the credential data conversion schema, and descriptions or types of the respective schemas, and may also include the identity information of the source credential issuer if necessary.

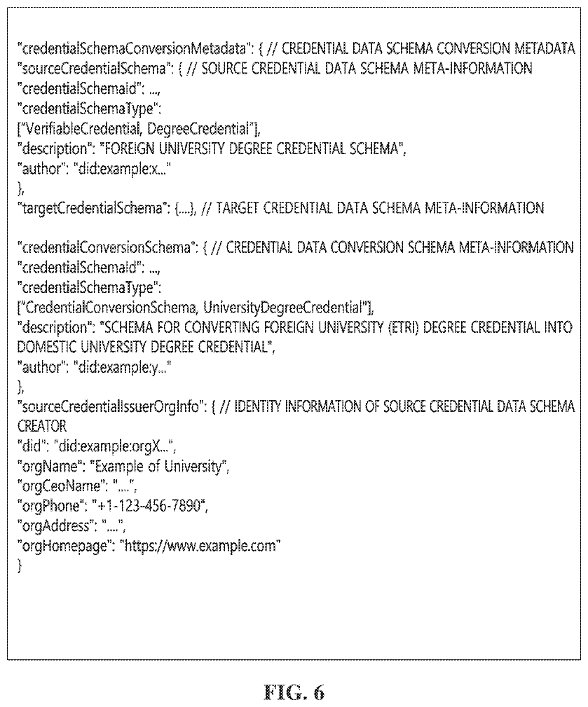

FIG. 6 is a diagram illustrating sample data of credential data schema conversion metadata according to an embodiment.

As illustrated in FIG. 6, credential data schema meta-information may be meta-information about the source credential data schema, the target credential data schema, and the credential data conversion schema used to convert the source credential data schema into the target credential data schema. The meta-information may include information about schema identifiers, types, descriptions, creators (authors), etc.

The identity information of the source credential data schema creator may be information about the issuer organization of the source credential. The organization information may be retrieved through an issuer identity information registry, and data about the organization information may include the decentralized identifier, name, representative (CEO) name, phone number, address, homepage address, etc. of the corresponding organization.

Referring back to FIG. 4, the credential data schema conversion result 650 may be information indicating the result of converting the source credential data schema into the target credential data schema.

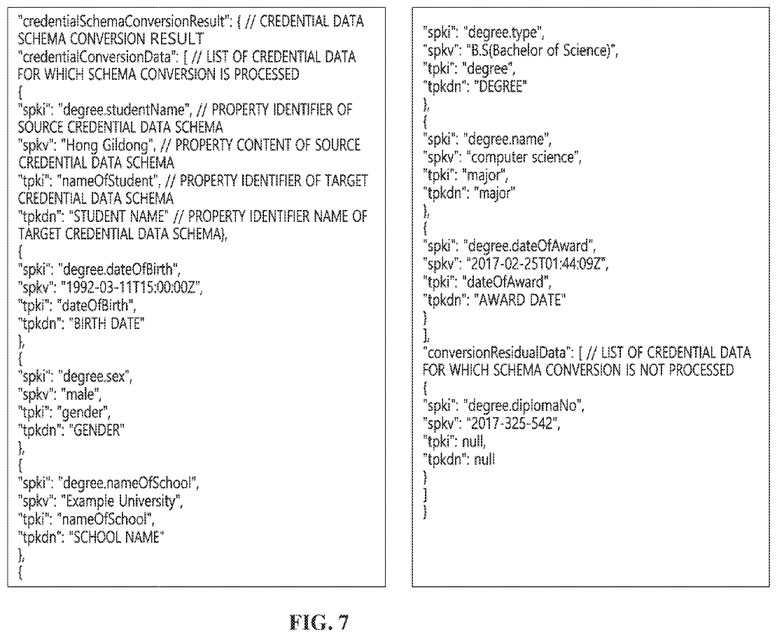

FIG. 7 is a diagram illustrating sample data of a credential data schema conversion result according to an embodiment.

As illustrated in FIG. 7, information indicating the credential data schema conversion result may include converted credential data schema information and source credential data schema information that is not converted (i.e., unconverted credential data schema information).

Referring back to FIG. 4, the guarantee information 670 of the credential data schema conversion result may include information of a signature made by the converter.

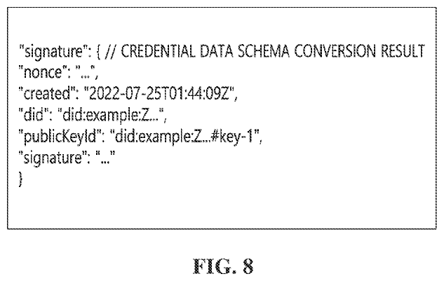

FIG. 8 is a diagram illustrating sample data indicating the guarantee information of credential data schema conversion result according to an embodiment.

As illustrated in FIG. 8, the guarantee information of the credential data schema conversion result may be information in which the credential data schema conversion data is signed with a private key associated with the decentralized identifier of the converter.

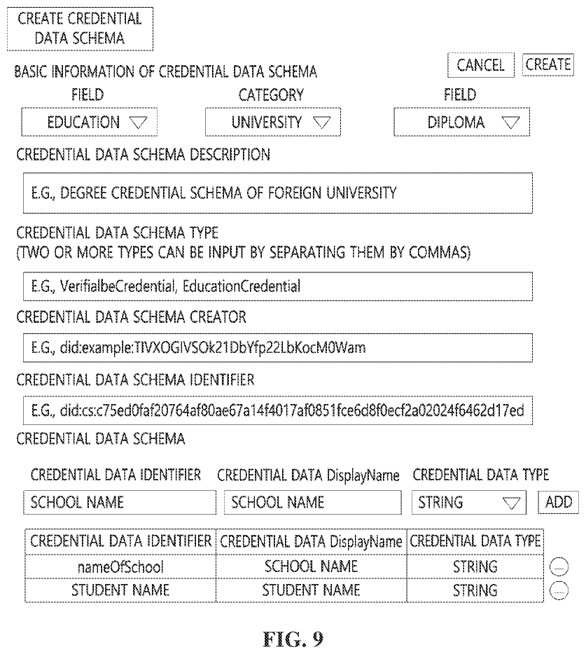

FIG. 9 is a diagram illustrating a User Interface (UI) screen for creating a credential data schema according to an embodiment.

As illustrated in FIG. 9, the credential data schema may be configured such that a credential data schema converter may create and manage credential data schemas for credentials.

The UI screen for creating credential data schemas may be composed of sections for creating basic information, description, a type, a creator, an identifier, and a schema related to each credential data schema.

For the basic information of the credential data, fields and detailed classification of the credential data may be set. The description of the credential data schema may describe the credential data schema converter of the credential data schema. The type and creator of the credential data schema may utilize the property information of each credential. The type of the credential data schema may be data defined in 4.3 Types in the W3C Verifiable Credentials Data Model, and the creator thereof may be data defined in 4.5 Issuer therein.

The identifier of the credential data schema may be the information of an identifier by which the credential data schema of the corresponding credential can be identified, and may be automatically generated. The credential data schema identifier may be a value obtained by hashing data that connects the credential data schema type and creator information to each other.

For example, the credential data schema identifier may be a value obtained by calculating sha256(VerifialbeCredentialEducationCredentialdid:example:TIVXOGlVSOk21DbYf p22LbKocM0Wam), and the final credential data schema identifier using the hash value may be represented by “did:cs:c75ed0faf20764aMae67a14f4017af0851fce6d8f0ecf2a02024f6462d17ed”.

The credential data schema may be created using a UI which creates a credential data schema for the corresponding credential. The credential data schema may be composed of a credential data identifier, credential data DisplayName, and credential data type, and the credential data schema converter may directly create respective credential data schemas based on the credential property information (defined in 4.4 Credential Subject in W3C Verifiable Credentials Data Model).

The credential data identifier may be an identifier value in the credential property information. For example, in the example of the source credential of FIG. 5, the credential data identifier of a student name may be set to ‘degree.studentName’. The credential data DisplayName may be a character string allowing a person to understand the credential data identifier. The credential data type may indicate various types of data formats that are interpretable by the computer. For example, as illustrated in FIG. 5, the credential data identifier of a student name may be set to ‘degree.studentName’. The credential data DisplayName may be a character string allowing a person to understand the credential data identifier, for example, ‘student name’.

The credential data type may indicate various types of data formats that are interpretable by the computer.

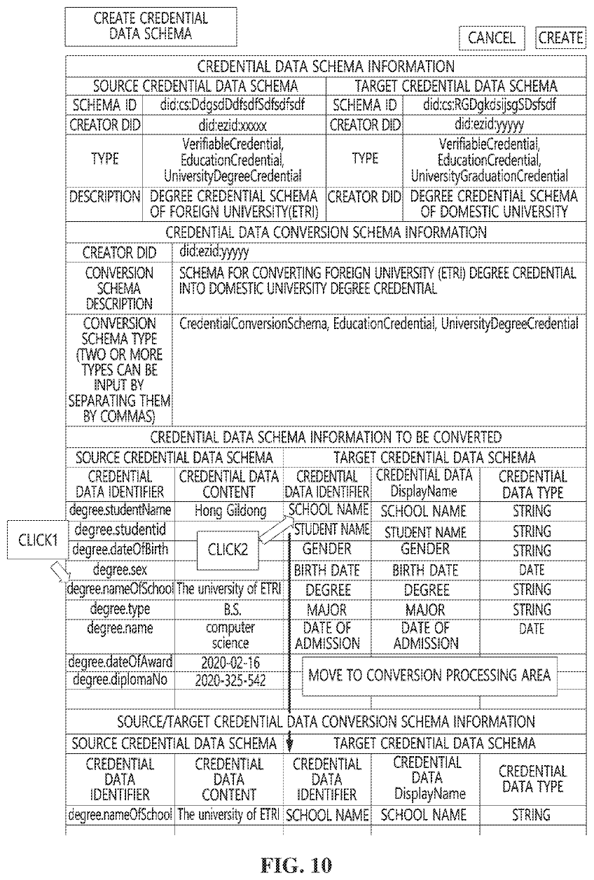

FIG. 10 is a diagram illustrating a User Interface (UI) screen for creating a credential data conversion schema according to an embodiment.

As illustrated in FIG. 10, the credential data conversion schema may allow a credential data schema converter to create and manage a credential data conversion schema by which a source credential data schema can be converted into a target credential data schema.

The UI screen for creating the credential data conversion schema may be composed of credential data schema information, credential data conversion schema information, credential data schema information to be converted, and source/target credential data conversion schema information.

In the credential data schema information, meta-information of a source credential data schema and a target credential data schema related to a credential data conversion schema to be created may be written. Each credential data schema may be created based on the credential data schema information created in FIG. 9.

In the credential data conversion schema information, meta-information of a credential data conversion schema for converting the source credential data schema into the target credential data schema may be set.

As the credential data schema information to be converted, both the source credential data schema information and the target credential data schema information that are created in FIG. 9 are output. The credential data schema converter may create the credential data conversion schema by connecting pieces of credential data having the same meaning.

The source/target credential data conversion schema information may indicate pieces of credential data conversion schema information connected through the credential data schema information to be converted.

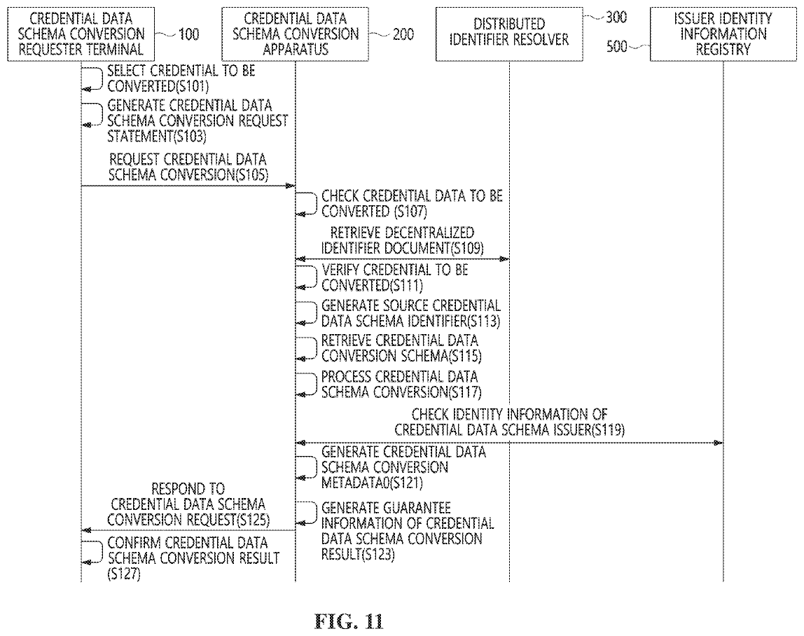

FIG. 11 is a flowchart illustrating the entire process of a method for converting a credential data schema (hereinafter also referred to as a “credential data schema conversion method”) according to an embodiment.

As illustrated in FIG. 11, a requester terminal 100 may select a credential to be converted based on the input of a requester at step S101, and may generate a credential data schema conversion request statement at step S103. The requester terminal 100 may request the credential data schema conversion apparatus 200 to convert a credential data schema based on the credential data schema conversion request statement at step S105.

The credential data schema conversion apparatus 200 may check a credential document included in the credential data schema conversion request statement, and may check the decentralized identifier of a credential issuer at step S107.

The credential data schema conversion apparatus 200 may retrieve the decentralized identifier document of the credential issuer using a decentralized identifier resolver 300 so as to verify whether the credential is forged/falsified at step S109.

The credential data schema conversion apparatus 200 may verify whether the credential is forged/falsified using the retrieved decentralized identifier document of the credential issuer at step S111.

The credential data schema conversion apparatus 200 may generate a credential data schema identifier for the credential at step S113. Here, the credential data schema identifier may be generated using the type information of the credential and the decentralized identifier information of the issuer, or may be generated using information about the data schema of the credential. The data schema information may be credentialSchema Id information in the W3C Verifiable Credentials Data Model (5.4 Data Schemas).

The credential data schema conversion apparatus 200 may retrieve a credential data conversion schema that enables conversion into the credential data schema requested by the requester based on the generated credential data schema identifier at step S115.

The credential data schema conversion apparatus 200 may convert the credential data schema using the retrieved credential data conversion schema, and may generate a credential data schema conversion result including converted credential data schema information and unconverted credential data schema information at step S117.

The credential data schema conversion apparatus 200 may check the identity information of a source credential issuer through an issuer identity information registry 500 in order to generate credential data schema conversion metadata at step S119.

The credential data schema conversion apparatus 200 generates credential data schema conversion metadata required to improve the reliability of the credential data schema conversion data at step S121. The credential data schema conversion metadata may be composed of meta-information of a source credential data schema, meta-information of a target credential data schema, meta-information of the credential data conversion schema, and identity information of the credential issuer.

The credential data schema conversion apparatus 200 may generate guarantee information of the credential data schema conversion result, signed with a private key associated with the decentralized identifier of the converter in order to verify the integrity of the credential data schema conversion result and the credential data schema conversion metadata at step S123.

The credential data schema conversion apparatus 200 may create a response statement responding to the credential data schema conversion request and provide the response statement to the requester terminal at step S125. The credential data schema conversion response statement may be composed of the credential document, the conversion of which is requested by the requester terminal, the credential data schema conversion metadata, the credential data schema conversion result, and the guarantee information of the credential data schema conversion result.

The requester terminal 100 may verify the guarantee information of the credential data schema conversion result in the credential data schema conversion response statement made by the converter, and may confirm both the credential data schema conversion result and the metadata at step S127.

The credential data schema conversion apparatus according to an embodiment may be implemented in a computer system such as a computer-readable storage medium.

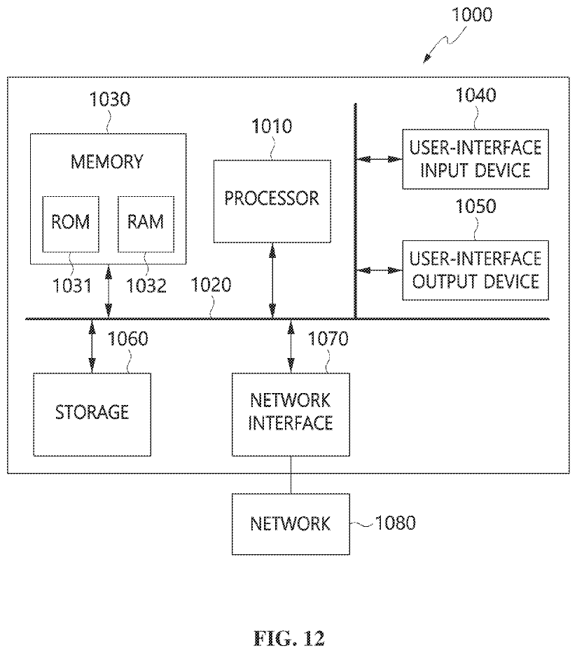

FIG. 12 is a block diagram illustrating the configuration of a computer system according to an embodiment.

Referring to FIG. 12, a computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080.

Each processor 1010 may be a Central Processing Unit (CPU) or a semiconductor device for executing programs or processing instructions stored in the memory 1030 or the storage 1060. The processor 1010 may be a kind of CPU, and may control the overall operation of the credential data schema conversion apparatus.

The processor 1010 may include all types of devices capable of processing data. The term processor as herein used may refer to a data-processing device embedded in hardware having circuits physically constructed to perform a function represented in, for example, code or instructions included in the program. The data-processing device embedded in hardware may include, for example, a microprocessor, a CPU, a processor core, a multiprocessor, an application-specific integrated circuit (ASIC), a field-programmable gate array (FPGA), etc., without being limited thereto.

The memory 1030 may store various types of data for the overall operation such as a control program for performing a credential data schema conversion method according to an embodiment. In detail, the memory 1030 may store multiple applications executed by the credential data schema conversion apparatus, and data and instructions for the operation of the credential data schema conversion apparatus.

Each of the memory 1030 and the storage 1060 may be a storage medium including at least one of a volatile medium, a nonvolatile medium, a removable medium, a non-removable medium, a communication medium, an information delivery medium or a combination thereof. For example, the memory 1030 may include Read-Only Memory (ROM) 1031 or Random Access Memory (RAM) 1032.

In accordance with an embodiment, a computer-readable storage medium for storing a computer program may include instructions enabling the processor to perform a method including an operation of checking credential data in response to a credential data schema conversion request statement received from a requester terminal, and checking a decentralized identifier of a credential issuer based on the credential data, an operation of retrieving a decentralized identifier document through a decentralized identifier resolver, an operation of verifying a credential to be converted based on the decentralized identifier document, an operation of, when verification of the credential is completed, generating a credential data schema identifier for the credential, an operation of retrieving a credential data conversion schema corresponding to the credential data schema conversion request statement based on the credential data schema identifier, an operation of converting the credential data schema based on the credential data conversion schema and generating a credential data schema conversion result, and an operation of checking identity information of the credential issuer through an issuer identity information registry.

In accordance with an embodiment, a computer program stored in a computer-readable storage medium may include instructions enabling the processor to perform a method including an operation of checking credential data in response to a credential data schema conversion request statement received from a requester terminal, and checking a decentralized identifier of a credential issuer based on the credential data, an operation of retrieving a decentralized identifier document through a decentralized identifier resolver, an operation of verifying a credential to be converted based on the decentralized identifier document, an operation of, when verification of the credential is completed, generating a credential data schema identifier for the credential, an operation of retrieving a credential data conversion schema corresponding to the credential data schema conversion request statement based on the credential data schema identifier, an operation of converting the credential data schema based on the credential data conversion schema and generating a credential data schema conversion result, and an operation of checking identity information of the credential issuer through an issuer identity information registry.

The particular implementations shown and described herein are illustrative examples of the present disclosure and are not intended to limit the scope of the present disclosure in any way. For the sake of brevity, conventional electronics, control systems, software development, and other functional aspects of the systems may not be described in detail. Furthermore, the connecting lines or connectors shown in the various presented figures are intended to represent exemplary functional relationships and/or physical or logical couplings between the various elements. It should be noted that many alternative or additional functional relationships, physical connections, or logical connections may be present in an actual device. Moreover, no item or component may be essential to the practice of the present disclosure unless the element is specifically described as “essential” or “critical”.

The embodiments may reduce a cost problem that occurs in a process of mechanically identifying and aggregating various credential data schemas.

Further, the embodiments may contribute to improving the scalability and interoperability of a decentralized identity management service.

Although the embodiments of the present invention have been disclosed with reference to the attached drawing, those skilled in the art will appreciate that the present invention can be implemented in other concrete forms, without changing the technical spirit or essential features of the invention. Therefore, it should be understood that the foregoing embodiments are merely exemplary, rather than restrictive, in all aspects.

What is claimed is:

1. A method for converting a credential data schema, comprising:
checking credential data in response to a credential data schema conversion request statement received from a requester terminal, and checking a decentralized identifier of a credential issuer based on the credential data;
retrieving a decentralized identifier document through a decentralized identifier resolver;
verifying a credential to be converted based on the decentralized identifier document;
when verification of the credential is completed, generating a credential data schema identifier for the credential;
retrieving a credential data conversion schema corresponding to the credential data schema conversion request statement based on the credential data schema identifier;
converting the credential data schema based on the credential data conversion schema and generating a credential data schema conversion result; and
checking identity information of the credential issuer through an issuer identity information registry.

2. The method of claim 1, further comprising:
generating credential data schema conversion metadata for the converted credential data schema.

3. The method of claim 2, wherein the credential data schema conversion metadata includes at least one of meta-information of a source credential data schema, meta-information of a target credential data schema, meta-information of a credential data conversion schema or the identity information of the credential issuer, or a combination thereof.

4. The method of claim 2, further comprising:
generating guarantee information of the credential data schema conversion result, signed with a private key associated with a decentralized identifier of a converter in order to verify integrity of the credential data schema conversion result and the credential data schema conversion metadata.

5. The method of claim 4, further comprising:
providing a credential data schema conversion response statement including at least one of a credential document, the credential data schema conversion metadata, the credential data schema conversion result or the guarantee information of the credential data schema conversion result, or a combination thereof to the request terminal in response to the credential data schema conversion request statement.

6. The method of claim 5, wherein the requester terminal verifies the guarantee information of the credential data schema conversion result based on the credential data schema conversion response statement, and confirms the credential data schema conversion result and the credential data schema conversion metadata.

7. The method of claim 1, wherein the credential data schema identifier is generated based on type information of the credential and decentralized identifier information of the credential issuer.

8. The method of claim 1, wherein the credential data schema identifier is generated based on information about a data schema of the credential.

9. The method of claim 1, wherein the credential data schema conversion result includes converted credential data schema information and unconverted credential data schema information.

10. The method of claim 1, wherein the credential data conversion schema is created based on input of a converter, and the created credential data conversion schema is registered and managed using a credential data conversion schema repository.

11. An apparatus for converting a credential data schema, comprising:
a memory configured to store a control program for converting a credential data schema; and
a processor configured to execute the control program stored in the memory,
wherein the processor is configured to check credential data in response to a credential data schema conversion request statement received from a requester terminal, check a decentralized identifier of a credential issuer based on the credential data, retrieve a decentralized identifier document through a decentralized identifier resolver, verify a credential to be converted based on the decentralized identifier document, when verification of the credential is completed, generate a credential data schema identifier for the credential, retrieve a credential data conversion schema corresponding to the credential data schema conversion request statement based on the credential data schema identifier, convert the credential data schema based on the credential data conversion schema, generate a credential data schema conversion result, and check identity information of the credential issuer through an issuer identity information registry.

12. The apparatus of claim 11, wherein the processor is configured to generate credential data schema conversion metadata for the converted credential data schema.

13. The apparatus of claim 12, wherein the credential data schema conversion metadata includes at least one of meta-information of a source credential data schema, meta-information of a target credential data schema, meta-information of a credential data conversion schema or the identity information of the credential issuer, or a combination thereof.

14. The apparatus of claim 12, wherein the processor is configured to generate guarantee information of the credential data schema conversion result, signed with a private key associated with a decentralized identifier of a converter in order to verify integrity of the credential data schema conversion result and the credential data schema conversion metadata.

15. The apparatus of claim 14, wherein the processor is configured to provide a credential data schema conversion response statement including at least one of a credential document, the credential data schema conversion metadata, the credential data schema conversion result or the guarantee information of the credential data schema conversion result, or a combination thereof to the request terminal in response to the credential data schema conversion request statement.

16. The apparatus of claim 15, wherein the requester terminal verifies the guarantee information of the credential data schema conversion result based on the credential data schema conversion response statement, and confirms the credential data schema conversion result and the credential data schema conversion metadata.

17. The apparatus of claim 11, wherein the credential data schema identifier is generated based on type information of the credential and decentralized identifier information of the credential issuer.

18. The apparatus of claim 11, wherein the credential data schema identifier is generated based on information about a data schema of the credential.

19. The apparatus of claim 11, wherein the credential data schema conversion result includes converted credential data schema information and unconverted credential data schema information.

20. The apparatus of claim 11, wherein the credential data conversion schema is created based on input of a converter, and the created credential data conversion schema is registered and managed using a credential data conversion schema repository.
